(19) United States
(12) Patent Application Publication
(10) Pub. No.: US 2008/0137819 A1
(43) Pub. Date: Jun. 12, 2008

(54) METHOD AND SYSTEM FOR SERVING ADVERTISING CONTENT THROUGH INTERNET GENERATED CALLS AND WEB VOICEMAILS

(75) Inventor: Yakov TEMOV, Los Gatos, CA (US)

Correspondence Address: SAWYER LAW GROUP LLP, P O BOX 51418, PALO ALTO, CA, 94303, US

(73) Assignee: Voice4Biz, Inc., Los Gatos, CA (US)

(21) Appl. No.: 11/950,367

(22) Filed: Dec. 4, 2007

Related U.S. Application Data
(60) Provisional application No. 60/872,967, filed on Dec. 4, 2006.

(51) Int. Cl. H04M 1/64

(52) U.S. Cl. 379/88.17

(57) ABSTRACT

A method for serving an advertisement through an Internet generated telephone call between a user and a second party. The method includes displaying a form field on an Internet website associated with the second party; receiving user input entering a telephone number and other information requested of the user into the form field on the Internet website; establishing a telephone call between the user and the second party using the telephone number; and prior to connecting the user to the second party, playing a first recorded voice advertisement to the user that is determined by user information, and second party information, and coordinated with the content and rich media of the form field.

### FIELD OF THE INVENTION

The present invention relates generally to advertising.

### BACKGROUND OF THE INVENTION

Advertising is generally an important part of a promotional strategy associated with goods and services. Advertisers have traditionally placed advertisements in media, such as television, radio, newspapers and magazines. Recently, advertising over more interactive media (e.g., Internet websites) has become popular. For example, a website-based advertisement is typically presented to a viewer in the form of a “banner ad”—i.e., a rectangular box that includes graphic components. The viewer can activate the banner ad by clicking on the banner ad, and an embedded hypertext link in the banner ad will direct the viewer to the advertiser's website.

### SUMMARY OF THE INVENTION

In general, this specification describes a method of empowering an end user to create, publish, administrate, and track rich media and video enabled internet applications (banner, widgets, pages, and so on) that incorporate a process for serving advertising content through a coordination of online media, video, Internet generated telephone calls (including calls with direct multimedia embedded within), Web voicemails, and video and telephony enabled email.

In one implementation, a method for serving an advertisement through, e.g., an Internet generated telephone call, between a user and a second party is disclosed. The method includes displaying a flash enabled video with embedded text and input fields on an Internet website associated with the second party, and receiving user input entering a telephone number (or more generally a contact number or ID, as discussed in greater detail below), and any other information requested of the user into the input field on the Internet website. The method further includes establishing communication (e.g., a telephone call) (or more generally a connection) between the user and the second party using the telephone number (or contact number or ID), and prior to connecting the user to the second party, playing a first recorded voice advertisement to the user that is determined and targeted in accordance with an extrapolation of the users' information, and coordinated with the rich media that plays simultaneously on the internet website associated with the second party.

Particular implementations can include one or more of the following features. The method can further include displaying advertising content (e.g., a rich media or video widget or banner ad) to the user during and/or after the establishment of the communication (or connection) between the user and the second party. The first banner ad and the input field can be displayed on a first page of the Internet website. Alternatively, the input fields can be displayed on a first page of the Internet website, and the first banner ad can be displayed on a (different) second page of the Internet website. The first banner ad can be displayed on a display screen of a telephone of the user. The telephone of the user can be a mobile device—e.g., a wireless PDA (personal digital assistant), cellular phone, or other two-way communication device. The method can further include receiving user input specifying a time to initiate the establishment of the telephone call between the user and the second party, in which establishing communication can include establishing the communication between the user and the second party at the user-specified time.

Particular implementations can further include one or more of the following features. The method can further include displaying a second banner ad to the second party during the establishment of communication between the user and the second party. The first banner ad and the second banner ad can be coordinated, or different. The method can further include playing a second recorded voice advertisement to the second party prior to connecting the user to the second party. The second banner advertisement can be displayed on a display screen of a communication device (e.g., a telephone, PDA, or other communication device) of the second party. The communication device of the second party can be a mobile device. At least one of the first recorded voice advertisement, the second recorded voice advertisement, the first banner advertisement, or the second banner advertisement can be context dependent or static dependent. The first recorded voice advertisement and the second recorded voice advertisement can be coordinated or different. In general, an advertisement is context dependent or static dependent in that the advertisement corresponds to one or more of a subject matter, or content of the Internet website, a geographic location of the second party, an area code of telephone number entered by the user, a uniform resource locator (URL) of the Internet website, a keyword associated with the Internet website, or any other information derived through a user or second party's interface.

In general, in another aspect, this specification describes a method for serving an advertisement through an Internet voicemail service, in which the Internet voicemail service permits a user to leave a voicemail for a second party. In one implementation, the method includes displaying an input field on an Internet website associated with the second party, and receiving user input entering a telephone number (or contact number or ID) of the user into the form field on the Internet website. The method further includes connecting the user to the Internet voicemail service, and (prior to connecting the user to the Internet voicemail service) playing a first recorded voice advertisement, and or coordinated rich media/video advertisement to the user.

Particular implementations can include one or more of the following features. The method can further include displaying a first banner ad to the user during the connection of the user to the Internet voicemail service. The first banner ad and the input field can be displayed on a first page of the Internet website. Alternatively, the input field can be displayed on a first page of the Internet website and the first banner advertisement can be displayed on a second page of the Internet website. The first banner advertisement can be displayed on a display screen of a communication device of the user. The method can further include connecting the second party to the Internet voicemail service to permit the second party to retrieve the voicemail; and (prior to connecting the second party to the Internet voicemail service) playing a second recorded voice advertisement to the second party. The method can further include displaying a second banner advertisement to the second party during the connection of the second party to the Internet voicemail service. The content of the first banner ad and the second banner ad can be both derived from the context of the Internet website, advertisement, and/or the information provided by the user and/or the second party. The second banner ad can be displayed on a display screen of a communication device of the second party.

The details of one or more implementations are set forth in the accompanying drawings and the description below. Other features and advantages will be apparent from the description and drawings, and from the claims.

### BRIEF DESCRIPTION OF THE DRAWINGS

FIGS. 1A-1C illustrate example HTML or ADOBE (Macromedia) Flash forms.

FIG. 2 illustrates an example call progress screen in accordance with one implementation.

FIG. 3 illustrates a linking of categories and keywords for use in an algorithm to determine relevant advertisements to serve to a user.

FIG. 4 illustrates a method for submitting an HTML GET request to a page in accordance with one implementation.

FIG. 5 is a block diagram of a data processing system suitable for storing and/or executing program code in accordance with one implementation of the invention.

Like reference symbols in the various drawings indicate like elements.

### DETAILED DESCRIPTION OF THE INVENTION

This specification describes techniques an end user to create, publish, administrate, and track rich media and video enabled internet applications (banner, widgets, pages, et al.) for serving their own advertising content, and/or the advertising content of a third party through a coordination of online media, video, Internet generated telephone calls, Web voicemails, and video & telephony enabled email. In one implementation, a tool or application is provided that empowers an end user to create, publish, administrate, and track rich media and video enabled internet applications (banner, widgets, pages, et al.) for serving their own advertising content, and/or the advertising content of a third party through a coordination of online media, video, Internet generated telephone calls, Web voicemails, and video & telephony enabled email. In one implementation, a method for serving an advertisement through, e.g., an Internet generated telephone call, between a user and a second party is disclosed. The method includes displaying a flash enabled video with embedded text and input fields on an Internet website associated with the second party, and receiving user input entering a telephone number (or more generally a contact number or ID, as discussed in greater detail below), and any other information requested of the user into the input field on the Internet website. The method further includes establishing communication (e.g., a telephone call) (or more generally a connection) between the user and the second party using the telephone number (or contact number or ID), and prior to connecting the user to the second party, playing a first recorded voice advertisement to the user that is determined and targeted in accordance with an extrapolation of the users' information, and coordinated with the rich media that plays simultaneously on the internet website associated with the second party.

The following description is presented to enable one of ordinary skill in the art to make and use the invention and is provided in the context of a patent application and its requirements. The present invention is not intended to be limited to the implementations shown but is to be accorded the widest scope consistent with the principles and features described herein.

### Serving Context Dependent Voice and Banner Ads

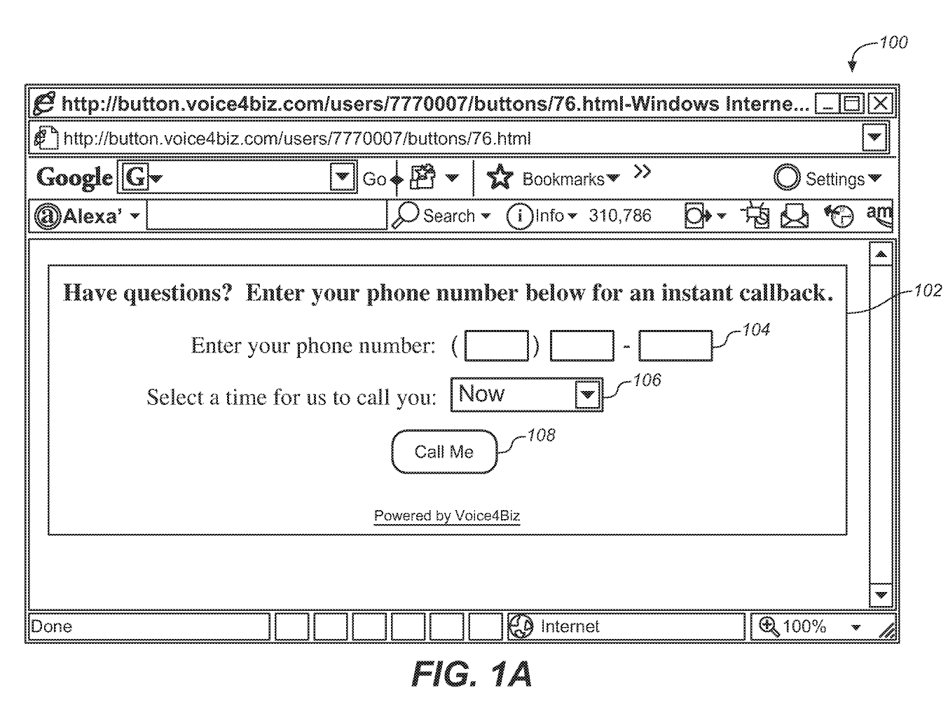

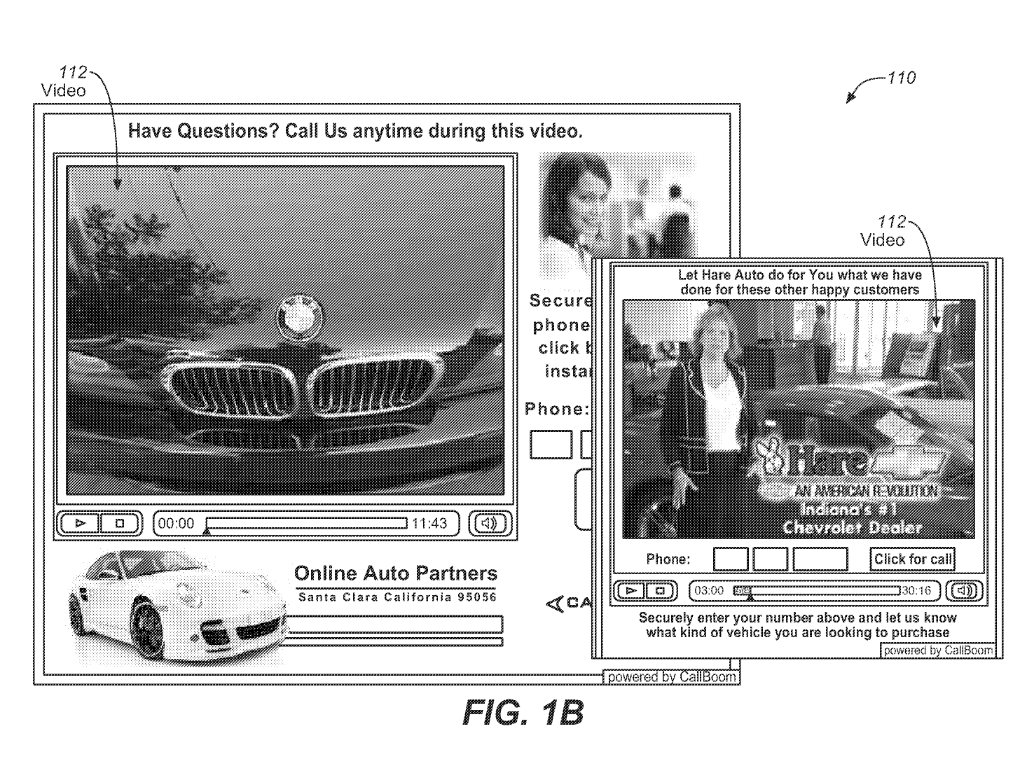

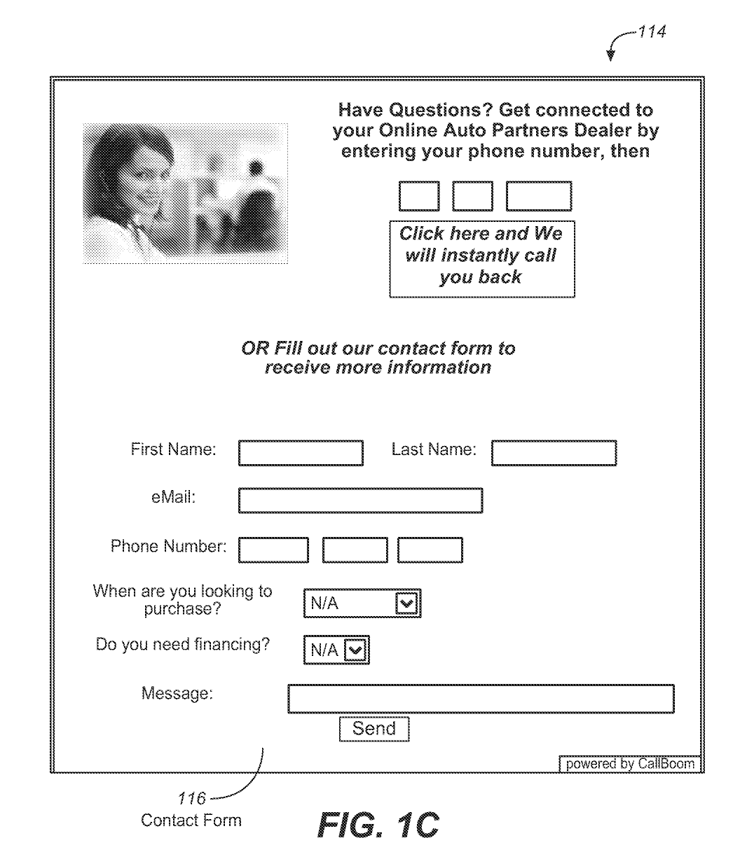

An Internet-generated call is a call that is (in one implementation) initiated through a web page and is placed through traditional Public Switched Telephone Network (PSTN) or using Voice Over IP (VoIP) infrastructure. FIG. 1 illustrates an example web page 100 through which an Internet-generated call can be initiated. In one implementation, Internet-generated calls are initiated through a button HTML or ADOBE (Macromedia) Flash interface form 102. As shown in FIG. 1, the button HTML or ADOBE (Macromedia) Flash interface form interface form 102 includes input fields 104-106. In particular, a user enters a phone number into input field 104, and enters a time to be called in input field 106. The button HTML or ADOBE (Macromedia) Flash interface form 102 further includes a button 108 that initiates a callback at the user-specified time. In one implementation, the button HTML or ADOBE (Macromedia) Flash interface form 102 is an insert of code (or a link to HTML file) that is placed into web pages—e.g., Ebay listings, MySpace profiles, Amazon stores, Craigslist advertisements, and so on. There are several scenarios for serving ads within Internet-generated calls.

FIG. 1B illustrates another example HTML interface form 110 through which a user can initiate an Internet-generated call. In one implementation, the HTML interface form 110 is an HTML, flash form. In the example of FIG. 1B, the HTML interface form 110 includes a video 112. Thus, a user may be prompted to initiate an Internet-generated call in response to questions concerning the video 112. FIG. 1C illustrates yet another example HTML interface form 114 through which a user can initiate an Internet-generated call. In the example of FIG. 1C, the HTML interface form 114 comprises a contact form 116.

### Scenario 1: Voice and Banner Ads Served to the Caller

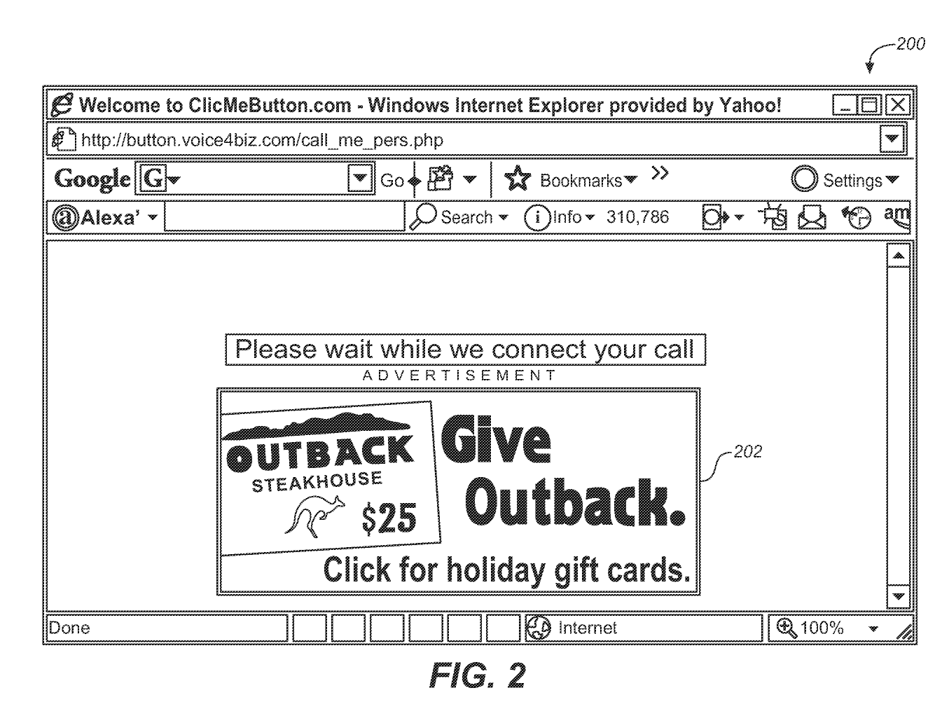

A persons initiating a call (Caller) enters his phone number into a button HTML or ADOBE (Macromedia) Flash interface form (e.g., button HTML or ADOBE (Macromedia) Flash interface form 102) and specifies the time to be called back. In one implementation, the screen changes to display the call progress to the Caller. FIG. 2 illustrates an example call progress screen that can be shown to the Caller. In one implementation, the call progress screen 200 includes a banner advertisement 202 located at the bottom of the call progress screen 200. In one implementation, at the user-specified time the Caller's phone rings and as soon as the Caller answers the phone, a short voice advertisement is played to the Caller. In one implementation, the short voice advertisement is followed by “Your call is now being connected”, and the Caller is immediately connected to the called party. In one implementation, the short voice advertisement played to the Caller is selected using context dependent advertisement placement techniques discussed below.

### Scenario 2: Voice Ad Served to the Called Party

A person initiating a call (Caller) enters the Caller's phone number into a button HTML or ADOBE (Macromedia) Flash interface form (e.g., button HTML or ADOBE (Macromedia) Flash interface form 102) and specifies the time to be called back. At the user-specified time, the Called party's phone number rings and when the Called party answers the phone, (in one implementation) the Called party hears a voice advertisement. The voice advertisement can be followed by, for example, the following voice directive—“Please press 1 to accept this call”. In response to the Called party pressing “1”, the Called party can then be immediately connected with the Caller. In one implementation, the voice advertisement played to the Called party is selected using context dependent advertisement placement techniques discussed below.

### Scenario 3: Voice and Banner Ads Served to Both the Calling and Called Parties

This scenario combines features of the scenarios discussed above. That is, in one implementation, the Caller can be served both a banner advertisement (through a call progress screen (e.g., call progress screen 200)) and a voice advertisement. In one implementation, the banner advertisement and the voice advertisement sent to the Caller are selected using context dependent advertisement placement techniques discussed below.

### Scenario 4: Voice and Banner Ads Served to Person Leaving a Voicemail

This scenario is identical to Scenario 1 except the user (in one implementation) presses a “Leave a voicemail” button instead of a “Call Me” button. According to this implementation, when the user picks up the phone to leave a voicemail, the user hears a voice advertisement—e.g., ‘This free voicemail service is brought to you by . . . followed by a voice advertisement”. In one implementation, the voice advertisement is selected using context dependent advertisement placement techniques discussed below.

### Context Dependent Advertisement Placement

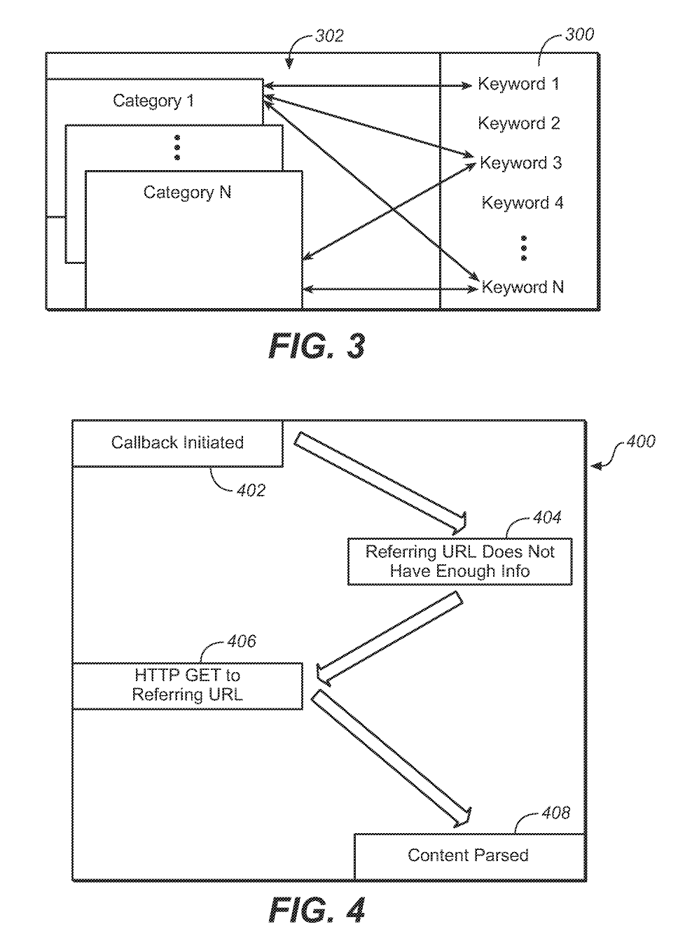

The method described below is used to determine which advertisements (e.g., banner advertisements and/or voice advertisements) are contextually compatible with a given web page (URL) from which a call originated from. In one implementation, this determination is made in real time by finding a category that includes the maximum number of keywords found within the referring site's URL, its metatags or its content. The catalog of categories and keywords can be organized as shown in FIG. 3. Specifically, FIG. 3 illustrates a keyword list 300 and a plurality of categories 302 (categories 1-N). In one implementation, the keyword list 300 contains all search terms that could be used by consumers to search for goods or services. An example of a keyword would be something like computer or car or something that specifically identifies a particular manufacturer such as Ford or Sony. In one implementation, each category 302 has a link to one or more keywords that are related to the category. Multiple categories can share subsets of keywords, for example, both Computers and Consumer Electronics categories can be linked to Sony and Toshiba, as both of these manufacturer make computers as well as electronics. Advertising sponsors can also explicitly select one of more categories related to products and services they want to advertise.

In one implementation, the first step in determining the advertisement category is to parse the URL of the page from which the call originated from. In one implementation, URLs have the following format: server name://parameter list. A server name could be, e.g., www.ebay.com or www.myspace.com, and the parameter list can be site specific. Whether a URL, list of metatags, or referring page's contents is being used to find a relevant category, unnecessary information needs to be stripped out from the URL, list of metatags, or referring page's contents. Unnecessary information includes, but is not limited to, the following: non-alphabetic characters, excluding < > used to encapsulate HTML keywords, words that are less than three characters in length (unless specifically included in the keyword list) and nouns and adjectives that are specifically excluded as being too generic (e.g., green or large). Also, dashes and underscores are converted to spaces to separate out words.

After the unnecessary information is removed, every remaining word in the URL is compared against the list of keywords and a compatibility score is calculated for every category. In one implementation, a compatibility score is calculated using the following algorithm. Every time a word matches one of the keywords linked to any category in the catalog, the compatibility score for that category is incremented by one point. If two adjacent words in a row match keywords linked to the same category, the compatibility score for that category is incremented by two points. For example, a URL containing the words Sony portable computer will result in the Consumer Electronics category receiving a score of 1 and the Computers category receiving a score of 2. However with a URL containing the words Sony computer with will result in the Computers category receiving a score of 3 because the words Sony and computer are adjacent to each other. In one implementation, once a compatibility score is calculated, every word in the URL category with the highest score is selected for the advertisement to be served. Should advertising sponsors select multiple categories for their products/services, a sum of scores for those categories can be used to select the highest ranking advertisement(s).

In some cases, however, a URL may not contain sufficient information to make assumptions about the referring page. Such information can then acquired by submitting an HTML GET request to the referring URL, and retrieving its contents. FIG. 4 illustrates a method 400 for submitting an HTML GET request to the referring URL. A call back is initiated (step 402). The call back can be initiated through a button HTML or ADOBE (Macromedia) Flash interface form as discussed above. A determination is made (e.g., by a data processing engine) that the referring URL does not have sufficient information to make assumptions about the referring page (step 404). An HTML GET request is sent to the referring URL to retrieve content associated with the page (step 406). Content associated with the page can include, for example, words, meta tags, and the like, that are associated with the page. Once the content is retrieved, the content is then parsed (step 408). The content can be formatted according using techniques discussed above, and the formatted data is then used to calculate compatibility scores based on the algorithm described above. In one implementation, when parsing site content as opposed to a URL, HTML formatting is taken into consideration. In one implementation, words that are in bold, italic or underlined increase the compatibility score by, e.g., 1.5 points. In some cases it may be sufficient to only process mega tags. Meta tags can be processed the same way as URLs.

In general, for the purposes of this specification a contact number or ID can include a regular analog or digital telephone number, cellular telephone number, a voice over IP telephone number, a GoogleTalk ID, a Yahoo Messenger ID, an MSN Messenger ID, Skype ID, or the like. Furthermore a communication between two parties can be established using two of more of the following devices: regular phone, voice over IP phone or softphone, cellular phone, PDA, Smartphone, Internet communication clients such as, GoogleTalk Client, Yahoo Messenger Client, Microsoft Messenger Client or Skype Client, and the like, or any other type of communications device or software application. Also, in addition to, or in lieu of displaying a banner ad, a text advertisement can be displayed to the user or party. Other types of advertisements can be conveyed to a user or party—e.g., an audio advertisement.

One or more of method steps described above can be generally performed by one or more programmable processors executing a computer program to perform functions by operating on input data and generating output. Generally, the invention can take the form of an entirely hardware embodiment, an entirely software embodiment or an embodiment containing both hardware and software elements. In one implementation, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

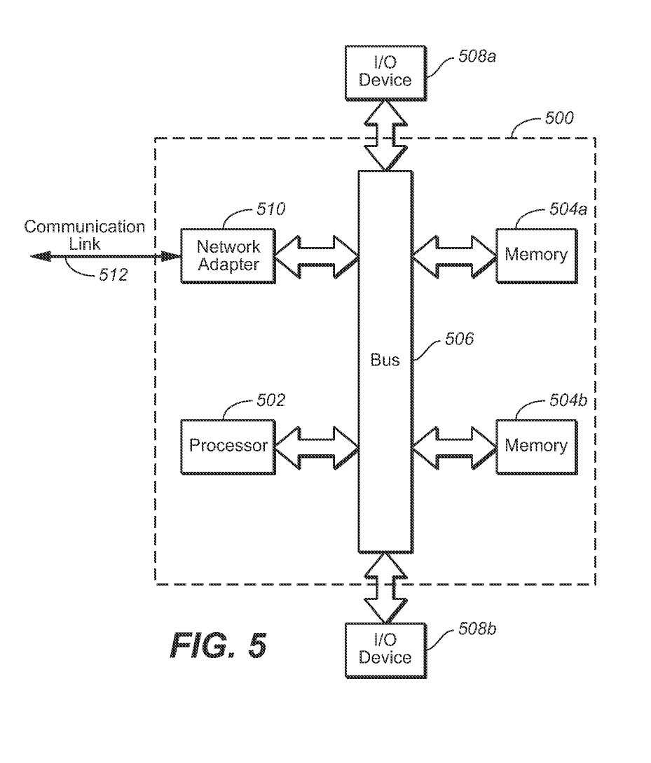

FIG. 5 illustrates a data processing system (or engine) 500 suitable for storing and/or executing program code. Data processing system 500 includes a processor 502 coupled to memory elements 504A-B through a system bus 506. In other implementations, data processing system 500 may include more than one processor and each processor may be coupled directly or indirectly to one or more memory elements through a system bus. Memory elements 504A-B can include local memory employed during actual execution of the program code, bulk storage, and cache memories that provide temporary storage of at least some program code in order to reduce the number of times the code must be retrieved from bulk storage during execution. As shown, input/output or I/O devices 508A-B (including, but not limited to, keyboards, displays, pointing devices, etc.) are coupled to data processing system 500. I/O devices 508A-B may be coupled to data processing system 500 directly or indirectly through intervening I/O controllers (not shown).

In one implementation, a network adapter 510 is coupled to data processing system 500 to enable data processing system 500 to become coupled to other data processing systems or remote printers or storage devices through communication link 512. Communication link 512 can be a private or public network. Modems, cable modems, and Ethernet cards are just a few of the currently available types of network adapters.

Various implementations for serving advertising content through Internet generated calls and Web voicemails. have been described. Nevertheless, various modifications may be made to the implementations. For example, steps of the methods described above can be performed in a different order and still achieve desirable results. Accordingly, many modifications may be made without departing from the scope of the following claims.

What is claimed is:

1. A method for serving an advertisement through an Internet generated telephone call between a user and a second party, the method comprising:
displaying a form field on an Internet website associated with the second party;
receiving user input entering a telephone number of the user into the form field on the Internet website;
establishing a telephone call between the user and the second party using the telephone number; and
prior to connecting the user to the second party, playing a first recorded voice advertisement to the user.

2. The method of claim 1, further comprising displaying a first banner advertisement to the user during the establishment of the telephone call between the user and the second party.

3. The method of claim 2, wherein the first banner advertisement and the form field are displayed on a first page of the Internet website.

4. The method of claim 2, wherein the form field is displayed on a first page of the Internet website and the first banner advertisement is displayed on a second page of the Internet website.

5. The method of claim 2, wherein the first banner advertisement is displayed on a display screen of a telephone of the user.

6. The method of claim 5, wherein the telephone of the user is a mobile phone.

7. The method of claim 1, further comprising:
receiving user input specifying a time to initiate the establishment of the telephone call between the user and the second party,
wherein establishing a telephone call includes establishing the telephone call between the user and the second party are the user-specified time.

8. The method of claim 1, further comprising prior to connecting the user to the second party, playing a second recorded voice advertisement to the second party.

9. The method of claim 8, wherein the first recorded voice advertisement and the second recorded voice advertisement are the same.

10. The method of claim 8, further comprising displaying a second banner advertisement to the second party during the establishment of the telephone call between the user and the second party.

11. The method of claim 10, wherein the first banner advertisement and the second banner advertisement are the same.

12. The method of claim 10, wherein the second banner advertisement is displayed on a display screen of a telephone of the second party.

13. The method of claim 12, wherein the telephone of the second party is a mobile phone.

14. The method of claim 10, wherein at least one of the first recorded voice advertisement, the second recorded voice advertisement, the first banner advertisement, or the second banner advertisement is context dependent.

15. The method of claim 14, wherein an advertisement is context dependent in that the advertisement corresponds to one or more of a subject matter of the Internet website, a geographic location of the second party, an area code of telephone number entered by the user, a uniform resource locator (URL) of the Internet website, a keyword associated with the Internet website.

16. A method for serving an advertisement through an Internet voicemail service, the Internet voicemail service permitting a user to leave a voicemail for a second party, the method comprising:
displaying a form field on an Internet website associated with the second party;
receiving user input entering a telephone number of the user into the form field on the Internet website;
connecting the user to the Internet voicemail service; and
prior to connecting the user to the Internet voicemail service, playing a first recorded voice advertisement to the user.

17. The method of claim 16, further comprising displaying a first banner advertisement to the user during the connection of the user to the Internet voicemail service.

18. The method of claim 17, wherein the first banner advertisement and the form field are displayed on a first page of the Internet website.

19. The method of claim 17, wherein the form field is displayed on a first page of the Internet website and the first banner advertisement is displayed on a second page of the Internet website.

20. The method of claim 17, wherein the first banner advertisement is displayed on a display screen of a telephone of the user.
